(19) United States
(12) Patent Application Publication
(10) Pub. No.: US 2018/0334401 A1
(43) Pub. Date: Nov. 22, 2018

(54) PLANT FOR THE PURIFICATION OF WASTE AND/OR PROCESS WATER BY MEANS OF ANAEROBIC MICROORGANISMS WITH A REACTOR TANK AND AN EXTERNAL SEPARATION APPARATUS

(71) Applicant: VOITH MERI ENVIRONMENTAL SOLUTIONS, INC., Appleton, WI (US)

(72) Inventors: Brad LEITNER, Appleton, WI (US); Lewis BLASZCZYK, Appleton, WI (US); George TROUBOUNIS, Munich (DE); Lucas MENKE, Munich (DE)

(21) Appl. No.: 15/601,074

(22) Filed: May 22, 2017

(51) Int. Cl. C02F 3/28; C02F 3/34

(52) U.S. Cl. CPC C02F 3/2866; C02F 3/2893; C02F 2003/008; C02F 3/34; C02F 3/28; C02F 3/282

(57) ABSTRACT

A plant for the anaerobic purification of waste and/or process water comprising:
i) a reactor tank with at least one feed line for supplying waste and/or process water into tank and with at least one outflow line for draining a mixture of microorganisms, waste and/or process water and gas from the tank,
ii) a first separation apparatus outside and downstream of the tank for separating at least a part of the microorganisms from the mixture from the tank, wherein the first separation apparatus comprises at least one separation stage, an inlet line connected with at least one of the outflow line(s), at least one discharge line and at least one outlet line, and
iii) a return line for returning the separated sludge separated into the reactor tank, wherein the return line connects with at least one of the at least one outlet line of the first separation apparatus.

### FIELD OF THE INVENTION

The present invention relates to a plant for the purification of waste and/or process water by means of anaerobic microorganisms, wherein the plant comprises a reactor tank, an external separation apparatus for separating anaerobic microorganisms from the mixture drained from the reactor tank and a return line for returning the separated anaerobic microorganism into the reactor tank. Moreover, the present invention relates to a method for purifying waste and/or process water, which is performed in such a plant.

### BACKGROUND OF THE INVENTION

A plurality of mechanical, chemical and biological processes and corresponding reactors are known for waste and/or process water purification. While waste water denotes water, which is designed to be disposed, process water denotes water, which is led in an industrial process in a closed loop.

In biological purification processes, the waste and/or process water to be purified is brought into contact with aerobic or anaerobic microorganisms which degrade the organic contaminants contained in the waste and/or process water primarily to carbon dioxide, biomass and water in the case of aerobic microorganisms and primarily to carbon dioxide and methane and only in a low proportion to biomass in the case of anaerobic microorganisms. In this respect, biological waste and/or process water purification methods have increasingly been carried out using anaerobic microorganisms in very recent times because in anaerobic waste and/or process water treatment oxygen does not have to be introduced into the bioreactor using high effort in energy, biogas rich in energy is produced in the treatment which can subsequently be used to gain energy and much smaller amounts of excess sludge are produced. Depending on the kind and form of the biomass used, the reactors for anaerobic waste and/or process water treatment are divided into contact sludge reactors, UASB reactors (“upflow anaerobic sludge blanker”), EGSB reactors (“expanded granular sludge bed”), fixed bed reactors and fluidized bed reactors. The microorganisms in fixed bed reactors adhere to stationary carrier materials and the microorganisms in fluidized bed reactors adhere to freely movable small carrier material, the microorganisms in the UASB and EGSB reactors are used in the form of so-called pellets. In contrast to UASB reactors, ESBG reactors are higher and have a much smaller foot print for the same volume.

For example, in UASB reactors and EGSB reactors waste and/or process water to be purified or a mixture of waste and/or process water to be purified and already purified waste and/or process water from the outflow of the anaerobic reactor is supplied continuously to the reactor via an inflow in the lower reactor region and is guided through a sludge bed located above the inflow and containing microorganism pellets. During the degradation of the organic compounds contained in the waste and/or process water as contaminants, the microorganisms form gas which contains methane and carbon dioxide (which is also referred to as biogas) some of which accumulates at the microorganism pellets in the form of small bubbles and some of which rises upwards in the reactor in the form of free gas bubbles. The specific weight of the pellets falls due to the accumulated gas bubbles so that the pellets rise upward in the reactor. To separate the biogas formed and the rising pellets from the water, separators are arranged in the middle and/or upper parts of the reactor, usually in the form of gas hoods under whose crowns biogas collects which forms a gas cushion under which a flotation layer of microorganism pellets and waste and/or process water is located. Purified water liberated from gas and microorganism pellets rises upwardly in the reactor and is drained off via overflows or submerged collection boxes, e.g. pipes with holes, at the upper end of the reactor, whereas the biogas collected at the separator as well as microorganism pellets and waste and/or process water from the flotation layer are drained off from the gas hoods of the separator and are conducted upwardly into a two phase separation device as a consequence of an airlift effect. The separation device is arranged on the top of the reactor. In the two-phase separation device gas is separated from the water and the microorganisms, wherein the gas is removed, while the suspension composed of the microorganisms and the water is returned via a downer line into the lower part of the anaerobic reactor. This recirculation of suspension is important to assure a possible high mixing of the components of the medium contained in the reactor, i.e. of microorganism pellets and water, because of the flow generated at the exit of downer line and the area around it. Such a high mixing of the single components of the medium contained in the reactor is important, to assure a continuous homogenous contact between the contaminated water and the microorganism which is an essential precondition for an efficient purification of the water, i.e. for an efficient conversion of the chemical oxygen demand (COD) to biogas. In contrast to this, an insufficient contact between the contaminated water and the microorganisms leads to a low mixing or inhomogeneous distribution of the contaminated water, which in turn leads to a locally partially conversion of COD and to the generation of an uneven distribution of the biogas production, which would lead to a decrease of purification efficiency of the reactor.

Such a reactor and a corresponding method are described, for example, in U.S. Pat. No. 8,066,877 B2.

However, the respective known reactors have, due to the included separators, such as gas hoods, several disadvantages. Firstly, the reactor must be terminated in operation and must be discharged, before maintenance work can be done at the gas hoods. Furthermore, because of the gas hoods a complex and expensive reactor design is necessary. In addition, the existing anaerobic reactors including gas hoods are customized for a specific purification method and are not tolerant to significant operational changes, such as the operation with a significantly differently calcium carbonate loading than they are designed for.

### SUMMARY OF THE INVENTION

In view of this, an object of the present invention is to provide a plant for the purification of waste and/or process water by means of anaerobic microorganisms, wherein the separation means for separating the anaerobic microorganism from the purified water and the gas can be easily maintained without necessarily terminating the operation of the reactor tank and at least without discharging the reactor tank, wherein the plant only requires a comparable simple and cost-efficiently designed reactor and wherein the plant is tolerant to significant operational changes, such as the operation with significantly differently calcium carbonate loadings.

In accordance with the present invention, this object is satisfied by a plant for the purification of waste and/or process water by means of anaerobic microorganisms, wherein the plant comprises:
i) a reactor tank for the anaerobic purification of waste and/or process water with at least one feed line for supplying waste and/or process water to be purified into the reactor tank as well as with at least one outflow line for draining a mixture of anaerobic microorganisms, waste and/or process water and gas from the reactor tank,
ii) a first separation apparatus arranged outside and downstream of the reactor tank for separating at least a part of the anaerobic microorganisms in form of sludge from the mixture drained from the reactor tank, wherein the first separation apparatus comprises at least one separation stage, an inlet line connected with at least one of the at least one outflow line of the reactor tank, at least one discharge line and at least one outlet line, and
iii) a return line for returning the sludge separated in the first separation apparatus into the reactor tank, wherein the return line is connected with at least one of the at least one outlet line of the first separation apparatus. Preferably, the separation apparatus for separating the anaerobic microorganism from the purified water and the gas can be maintained without necessarily terminating the operation of the reactor tank, and at least without discharging the reactor tank.

The plant, wherein the reactor tank does not comprise any gas hood and/or any other separation means for keeping the biomass in the reactor tank.

Thus, in contrast to the plants known in the prior art, in which the separation means for separating gas and sludge from the purified water particularly in the form of gas hoods are included in the reactor tank, in which the waste and/or process water to be purified is contacted with the anaerobic microorganism, in accordance with the present invention the respective separation means are provided outside of the reactor tank. Consequently, no separation occurs during the operation of the plant except from a possible first rough gas separation due to a bubbling out of gas from the three-phase mixture of gas, water and microorganism contained in the reactor tank, if the reactor tank is operated under pressure conditions and with a fluid level allowing such a gas bubbling. Rather, in accordance with the present invention the mixture comprising gas, water and microorganism contained in the reactor tank is continuously discharged from the reactor tank and separated in the one or more external separation apparatus located outside and downstream of the reactor tank into a sludge fraction containing all or at least most of the anaerobic microorganism discharged from the reactor tank, into a fraction consisting of or at least nearly completely consisting of purified water and into a gas fraction. Because of the reason that the separation means for separating and returning the biomass consisting of the anaerobic bacteria into the reactor tank are located outside the reactor tank, the plant of the present invention only requires a comparable simple and cost-efficient reactor tank, which does not comprise gas hoods or other separation means for keeping the biomass in the reactor tank. Due to this, the external separation means for separating the anaerobic microorganism from the purified water and the gas of the plant in accordance with the present invention can be easily maintained without necessarily terminating the operation of the reactor tank and at least without discharging the reactor tank. In addition, since the separation means are located outside of the reactor tank and can be thus easily customized to the needs, the plant in accordance with the present invention is tolerant to significant operational changes and is thus for example—in contrast to the respective plants known from the prior art—operable with significantly differently calcium carbonate loadings.

To remove the biomass or anaerobic bacteria, respectively, in form of sludge from three-phase mixture including anaerobic bacteria, water and gas after having been discharged from the reactor tank, the plant in accordance with the present invention can include as first separation apparatus any separation apparatus, which is suitable to efficiently remove anaerobic bacteria from such a three-phase mixture. The first separation apparatus may be a two-phase separator as well as a three-phase separation apparatus.

Good results are achieved, when the first separation apparatus comprises as separation stage(s) one or more centrifugal separators, such as when the first separation apparatus comprises as separation stage(s) one or more cyclones.

Alternatively, the first separation apparatus may comprise as separation stage(s) one or more lamella-separators. As set out above, a lamella-separator is a separator including at least two vertically arranged or sloped lamellae, wherein all lamellae are arranged in parallel with each other to define flow paths there between, so that the separation of gas from the waste and/or process water is facilitated.

The three-phase mixture discharged via the outflow line from the reactor tank may be transferred into the first separation apparatus either actively, for example by using a pump, or inactively, for instance by exploiting the gravitational force. To reduce the required energy consumption, it is preferred to transfer the three-phase mixture discharged via the outflow line from the reactor tank into the first separation apparatus by exploiting the gravitational force. More specifically, it is preferred that the first separation apparatus is in the plant lower than the upper end of that outflow line of the reactor tank, with which the inlet line of the first separation apparatus is connected. This allows that the mixture drained from the reactor tank flows gravity driven from that outflow line of the reactor tank into the inlet line of the first separation apparatus.

The present invention is not limited concerning the number of separation stages included in the first separation apparatus. Accordingly, the first separation apparatus may include one separation stage, two separation stages or even more separation stages.

According to a first preferred embodiment of the present invention, the plant contains a first external separation apparatus, which includes one separation stage. More specifically, it is preferred in this embodiment that the first separation apparatus comprises one cyclone, wherein the cyclone is connected with the inlet line, with one of the at least one outlet line and further with one of the at least one discharge line for discharging from the cyclone a mixture of anaerobic microorganisms, waste and/or process water and gas, which is depleted in the content of anaerobic microorganisms compared with the mixture drained from the reactor tank, wherein the outlet line to which the first cyclone is connected, is connected with the return line.

According to an alternative, second preferred embodiment of the present invention, the plant contains a first separation apparatus, which includes two separation stages. More specifically, it is preferred that the first separation apparatus comprises two cyclones, wherein the first of the two cyclones is connected with the inlet line, with one of the at least one outlet line for discharging from the first cyclone sludge and further with one of the at least one discharge line for discharging from the first cyclone a mixture of anaerobic microorganisms, waste and/or process water and gas, which is depleted in the content of anaerobic microorganisms compared with the mixture drained from the reactor tank, and wherein the second of the two cyclones is connected with the discharge line from the first cyclone, with another one of the at least one outlet line for discharging from the first cyclone sludge and further with another one of the at least one discharge line for discharging from the second cyclone a mixture of anaerobic microorganisms, waste and/or process water and gas, which is depleted in the content of anaerobic microorganisms compared with the mixture drained from the first cyclone, wherein the outlet line to which the first cyclone is connected and the outlet line to which the second cyclone is connected, are connected with the return line.

To improve the separation efficiency of the mixture discharged from the reactor tank, the plant further comprises in accordance with a further preferred embodiment of the present patent application a second separation apparatus, which is preferably a three-phase separation apparatus. The second separation apparatus, which is preferably a three-phase separation apparatus, is arranged outside the reactor tank and downstream of the first separation apparatus for separating the mixture withdrawn from the discharge line of the first separation apparatus into a gas-rich phase, into a water-rich phase and into a sludge-rich phase. The second separation apparatus, which is preferably a three-phase separation apparatus, comprises at least one separation stage, an inlet line connected with the discharge line of the first separation apparatus, at least one gas outlet line, at least one water outlet line and at least one sludge outlet line, wherein the at least one sludge outlet line is connected with the return line.

To get an excellent three-phase separation, it is preferred that the second, three-phase separation apparatus comprises as separation stage(s) one or more lamella-separators. As known to a person skilled in the art, a lamella-separator is a separator including at least two vertically arranged or sloped lamellae, wherein all lamellae are arranged in parallel with each other to define flow paths there between, so that the separation of gas from the waste and/or process water is facilitated.

The present invention is not limited concerning the number of separation stages included in the second separation apparatus. Accordingly, the second separation apparatus may include one separation stage, two separation stages or even more separation stages.

According to a first preferred embodiment of the present invention, the plant contains a second, three-phase separation apparatus, which comprises one lamella-separator, wherein the lamella-separator is connected with the inlet line, wherein the lamella-separator comprises a gas outlet line, a water outlet line and a sludge outlet line, wherein the sludge outlet line is connected with the return line.

According to an alternative, second preferred embodiment of the present invention, the plant contains a second, three-phase separation apparatus, which comprises two lamella-separators, wherein the first of the two lamella-separators is connected with the inlet line, wherein the first lamella-separator comprises a gas outlet line, a water outlet line and a sludge outlet line, and wherein the second of the two lamella-separators is connected with the water outlet line from the first lamella-separator and further comprises a gas outlet line, a water outlet line and a sludge outlet line, wherein the sludge outlet line of the first lamella-separator and the sludge outlet line of the second lamella-separator are connected with the return line.

In the case that the plant is operated under different flow conditions, it is preferred that the return line comprises a storage container or buffer container, respectively, which buffers a part of the flow stream through the return line to even changes of flow stream through the first separation apparatus to ensure a constant fluid flow returned via the return line into the reactor tank.

In a further development of the idea of the present invention it is proposed that the reactor tank of the plant comprises one or more overflows, wherein each of the overflows is connected with one of the at least one outflow line for draining a mixture of anaerobic microorganisms, waste and/or process water and gas from the reactor tank.

In this embodiment, each of the one or more overflows preferably comprises at least two vertically arranged or sloped lamellae, wherein all lamellae are arranged in parallel with each other to define flow paths there between, so that the separation of gas from the waste and/or process water is facilitated.

In the case that the plant shall be operated under pressure conditions and with a liquid level so that gas is partially already removed from the three-phase mixture included in the reactor tank by bubbling out, it is preferred that the upper part of the reactor tank is conically so that gas may be collected there and may be discharged therefrom via a gas line.

It is also possible, but not necessary that the bottom part of the reactor tank is conical.

In dependency from the ratio of height and diameter of the reactor tank, it might be also advantageous that the reactor tank of the plant comprises a mixer for improving the mixing of the waste and/or process water and the microorganism.

According to a further aspect, the present invention relates to a plant for the purification of waste and/or process water by means of anaerobic microorganisms, wherein the plant comprises:
i) a reactor tank for the anaerobic purification of waste and/or process water with at least one feed line for supplying waste and/or process water to be purified into the reactor tank as well as with at least one outflow line for draining a mixture of anaerobic microorganisms, waste and/or process water and gas from the reactor tank,
ii) a first separation apparatus arranged outside and downstream of the reactor tank for separating at least a part of the anaerobic microorganisms in form of sludge from the mixture drained from the reactor tank, wherein the first separation apparatus comprises at least one separation stage, an inlet line being connected with at least one of the at least one outflow line of the reactor tank, at least one discharge line and at least one outlet line, wherein the first separation apparatus comprises as separation stage(s) one or more cyclones, and
iii) a return line for returning the sludge separated in the first separation apparatus into the reactor tank, wherein the return line is connected with at least one of the at least one outlet line of the first separation apparatus.

According to still a further aspect, the present invention relates to a plant for the purification of waste and/or process water by means of anaerobic microorganisms, wherein the plant comprises:
i) a reactor tank for the anaerobic purification of waste and/or process water with at least one feed line for supplying waste and/or process water to be purified into the reactor tank as well as with at least one outflow line for draining a mixture of anaerobic microorganisms, waste and/or process water and gas from the reactor tank,
ii) a first separation apparatus arranged outside and downstream of the reactor tank for separating at least a part of the anaerobic microorganisms in form of sludge from the mixture drained from the reactor tank, wherein the first separation apparatus comprises at least one separation stage, an inlet line connected with at least one of the at least one outflow line of the reactor tank, at least one discharge line and at least one outlet line, and
iii) a return line for returning the sludge separated in the first separation apparatus into the reactor tank, wherein the return line is connected with at least one of the at least one outlet line of the first separation apparatus,

wherein the reactor tank does not comprise any gas hood and/or any other separation means for keeping the biomass in the reactor tank.

Another aspect of the present invention is a method for purifying waste and/or process water by means of anaerobic microorganisms, which comprises the steps of:
a) feeding waste and/or process water into the reactor tank of the plant described above via the at least one feed line,
b) draining a mixture of anaerobic microorganisms, waste and/or process water and gas from the reactor tank via the at least one outflow line and leading it into the first separation apparatus and
c) returning sludge separated in the first separation apparatus into the reactor tank via the return line.

All preferred embodiments described above for the plant also apply for the method.

It is preferred to perform the method with a plant described above, in which the first separation apparatus comprises one or more cyclones.

Preferably, the three-phase mixture discharged via the at least one outflow line from the reactor tank is transferred into the first separation apparatus gravity driven, for example by arranging the first separation apparatus in the plant to be lower than the upper end of that outflow line of the reactor tank, with which the inlet line of the first separation apparatus is connected.

According to a first preferred embodiment of the present invention, the method in accordance with the present invention is performed in a plant, which contains a first external separation apparatus, which includes one separation stage. More specifically, it is preferred that the first separation apparatus comprises one cyclone, wherein the cyclone is connected with the inlet line, with one of the at least one outlet line and further with one of the at least one discharge line for discharging from the cyclone a mixture of anaerobic microorganisms, waste and/or process water and gas, which is depleted in the content of anaerobic microorganisms compared with the mixture drained from the reactor tank, wherein the outlet line to which the first cyclone is connected, is connected with the return line.

According to an alternative, second preferred embodiment of the present invention, the method in accordance with the present invention is performed in a plant, which contains a first external separation apparatus, which includes two separation stages. More specifically, it is preferred that the first separation apparatus comprises two cyclones, wherein the first of the two cyclones is connected with the inlet line, with one of the at least one outlet line for discharging from the first cyclone sludge and further with one of the at least one discharge line for discharging from the first cyclone a mixture of anaerobic microorganisms, waste and/or process water and gas, which is depleted in the content of anaerobic microorganisms compared with the mixture drained from the reactor tank, and wherein the second of the two cyclones is connected with the discharge line from the first cyclone, with another one of the at least one outlet line for discharging from the first cyclone sludge and further with another discharge line for discharging from the second cyclone a mixture of anaerobic microorganisms, waste and/or process water and gas, which is depleted in the content of anaerobic microorganisms compared with the mixture drained from the first cyclone, wherein the outlet line to which the first cyclone is connected and the outlet line to which the second cyclone is connected, are connected with the return line.

According to a second preferred embodiment of the present invention, the method in accordance with the present invention comprises a second separation step, which is preferably a three-phase separation step, which is performed after the one or more stages of the first separation step. Also, the second separation step, preferably three-phase separation step, can be performed in one or more stages. For example, this embodiment is performed in a plant, which further includes a second, three-phase separation apparatus, which is arranged outside the reactor tank and downstream of the first separation apparatus for separating the mixture withdrawn from the discharge line of the first separation apparatus into a gas-rich phase, into a water-rich phase and into a sludge-rich phase. The second, three-phase separation apparatus preferably comprises at least one separation stage, an inlet line connected with the discharge line of the first separation apparatus, at least one gas outlet line, at least one water outlet line and at least one sludge outlet line, wherein the at least one sludge outlet line is connected with the return line.

To get an excellent three-phase separation, it is preferred that the second, preferably three-phase separation step is performed in an apparatus, which comprises as separation stage(s) one or more lamella-separators.

Thus, according to a preferred embodiment of the present invention, the method is performed in a plant, which contains a second, three-phase separation apparatus, which comprises one lamella-separator, wherein the lamella-separator is connected with the inlet line, wherein the lamella-separator comprises a gas outlet line, a water outlet line and a sludge outlet line, wherein the sludge outlet line is connected with the return line.

According to an alternative preferred embodiment of the present invention, the method is performed in a plant, which contains a second, three-phase separation apparatus, which comprises two lamella-separators, wherein the first of the two lamella-separators is connected with the inlet line, wherein the first lamella-separator comprises a gas outlet line, a water outlet line and a sludge outlet line, and wherein the second of the two lamella-separators is connected with the water outlet line from the first lamella-separator and further comprises a gas outlet line, a water outlet line and a sludge outlet line, wherein the sludge outlet line of the first lamella-separator and the sludge outlet line of the second lamella-separator are connected with the return line.

In the case that the plant is operated under different flow conditions, it is preferred that the method is performed so that the sludge to be returned from the first and optionally second separation apparatus via the return line is guided in the return line through a storage container or buffer container, respectively, which is filled at least to a certain extent with the sludge. This allows buffering a part of the flow stream through the return line to even changes of flow stream through the first separation apparatus to ensure a constant fluid flow returned via the return line into the reactor tank.

In a further development of the idea of the present invention it is proposed that the three-phase mixture of anaerobic microorganisms, waste and/or process water and gas is drained from the reactor tank via one or more overflows into the at least one outlet line. This allows to easily keep the liquid level in the reactor tank constant. Preferably, each of the overflows is connected with one of the at least one outflow line for draining a mixture of anaerobic microorganisms, waste and/or process water and gas from the reactor tank. In this embodiment, each of the one or more overflows preferably comprises at least two vertically arranged or sloped lamellae, wherein all lamellae are arranged in parallel with each other to define flow paths there between, so that the separation of gas from the waste and/or process water is facilitated.

Subsequently, the present patent application is described by way of example regarding advantageous embodiments and to the enclosed drawing.

### BRIEF DESCRIPTION OF THE DRAWINGS

There is shown:

FIG. 1 a schematic longitudinal sectional view of a plant for the purification of influent water by means of anaerobic microorganisms in accordance with an embodiment of the present invention.

### DETAILED DESCRIPTION OF THE INVENTION

The plant 10 for purifying waste and/or process water by means of anaerobic microorganisms comprises a reactor tank 12 for the anaerobic purification of waste and/or process water, a first separation apparatus 14 arranged outside and downstream of the reactor tank 12 for separating at least a part of the anaerobic microorganisms in form of sludge from the mixture drained from the reactor tank 12, a second three-phase separation apparatus 16 arranged outside the reactor tank and downstream of the first separation apparatus 14 for separating the sludge-depleted mixture withdrawn from the first separation apparatus 14 into a gas-rich phase, into a water-rich phase and into a sludge-rich phase as well as a return line 18 for returning the sludge separated in the first separation apparatus 14 and in the second separation apparatus 16 into the reactor tank 12.

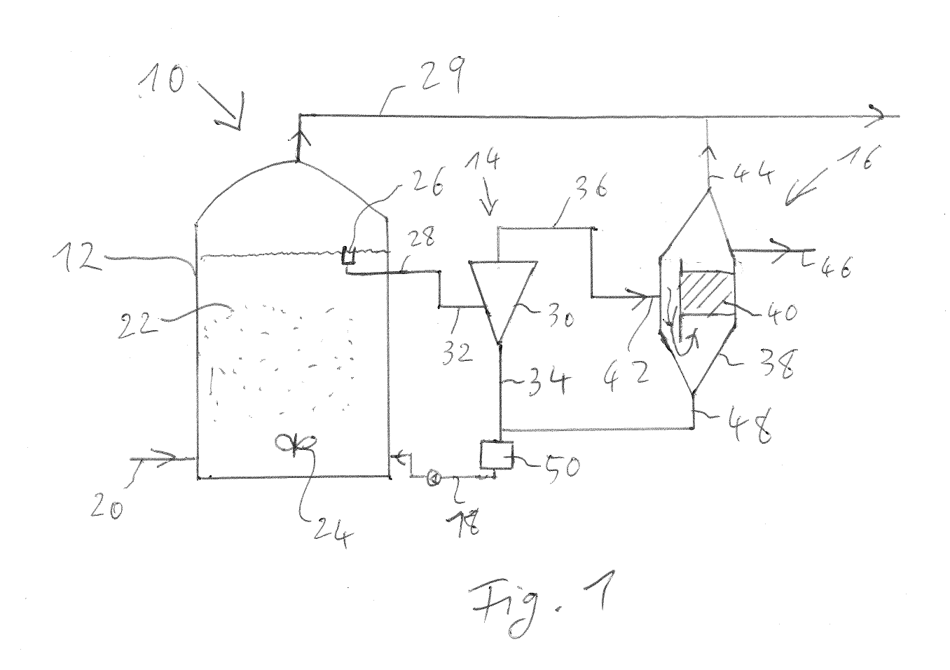

More specifically, the reactor tank 12 shown schematically in longitudinal section in FIG. 1 is made cylindrical in its lower and middle part and converges upwardly in a conical form in its upper part. The reactor tank 12 comprises one feed line 20, through which waste and/or process water to be purified is supplied into the reactor tank 12. The reactor tank 12 is filled until the lower end of the conical upper part with a mixture of anaerobic bacteria 22, with waste and/or process water and biogas generated by the anaerobic bacteria 22 during the operation of the plant 10. In the lower part, a mixer 24 is provided for homogeneously mixing the three phases. At the upper part of the reactor tank, an overflow 26 is provided, which is connected with an outflow line 28. During the operation of the plant continuously a part of the three-phase mixture is drained from the reactor tank 12 through the overflow 26 and outflow line 28. Furthermore, the reactor tank 12 comprises on its top a gas outlet line 29 for discharging a part of the gas generated by the anaerobic microorganism during the operation. In contrast to the reactors known from the prior art, no gas hoods or other separations devices are provided in the reactor tank.

Outside and downstream of the reactor tank 12, the first separation apparatus 14 for separating at least a part of the anaerobic microorganisms in form of sludge from the mixture drained from the reactor tank 12 is arranged, wherein the first separation apparatus 14 comprises one cyclone 30 as separation stage. The cyclone 30 is connected through an inlet line 32 with the outflow line 28 and thus with the reactor tank 12 and is further connected with an outlet line 34 for discharging a microorganism rich sludge fraction from the cyclone. The outlet line 34 is connected with the return line 18. In addition, the cyclone 30 is provided with a discharge line 36 for discharging from the cyclone a mixture of anaerobic microorganisms, waste and/or process water and gas, which is depleted in the content of anaerobic microorganisms compared with the mixture drained from the reactor tank 12.

As an alternative to the shown cyclone 30, the first separation apparatus 14 may comprise one or more lamella-separators instead of the cyclone 30 or in addition to the cyclone 30.

The second, three-phase separation apparatus 16, which is arranged outside the reactor tank and downstream of the first separation apparatus 14, comprises one lamella-separator 38 including several lamellae, wherein the lamella-separator 38 provides an inlet line 42, which is connected with the discharge line 36. Moreover, the lamella-separator 38 comprises a gas outlet line 44, a water outlet line 46 and a sludge outlet line 48. In turn, the sludge outlet line 48 is connected with the return line 18, wherein the return line 18 comprises a storage container 50.

During the operation of the plant 10, waste and/or process water to be purified is continuously supplied through the feed line 20 into the reactor tank 12 so that the reactor tank 12 is filled during the operation of the plant 10 until the lower end of the conical upper part with a mixture of anaerobic bacteria 22, with waste and/or process water and biogas generated by the anaerobic bacteria 22 during the operation of the plant 10. This mixture is homogeneously mixed by the mixer 24 provided in the lower part of the reactor tank 12. The anaerobic bacteria 22 degrade the organic contaminants contained in the waste and/or process water primarily to carbon dioxide and methane, which are dissolved and/or dispersed in the three-phase mixture. Some of the gas bubbles out of the mixture and collects in the upper conical part of the reactor tank 12 and is continuously discharged via the gas outlet line 29. Likewise, three-phase mixture of anaerobic bacteria 22, water and biogas is continuously discharged via the overflow 26 and the outflow line 28 and fed via the inlet line 32 into the cyclone 30 of the first separation apparatus.

In the cyclone 30, the three-phase mixture is separated into a microorganism depleted phase and into a microorganism enriched sludge phase, wherein the microorganism depleted phase is discharged from the cyclone 30 via the discharge line 36 and wherein the microorganism enriched sludge phase is discharged from the cyclone 30 via the outlet line 34.

The microorganism depleted phase is then fed via the inlet line 42 into the lamellae 40 containing lamella-separator 38 of the second three-phase separation apparatus 16. Therein, the mixture is separated into the three phases gas, water and sludge, wherein the gas is discharged via the gas outlet line 44, water is discharged via the water outlet line 46 and sludge is discharged via the sludge outlet line 48.

The sludge discharged from the first separation apparatus 14 and the sludge discharged from the second three-phase separation apparatus 16 are fed via the return line 18 back into the reactor tank 12. In this context, the storage container 50 assures that the sludge is evenly returned with a constant fluid flow into the reactor tank 12.

### REFERENCE NUMERAL LIST

10 Plant
12 Reactor tank
14 First separation apparatus
16 Second (three-phase separation) apparatus
18 Return line
20 Feed line
22 Anaerobic bacteria/Microorganism
24 Mixer
26 Overflow
28 Outflow line
29 Gas outlet line
30 Cyclone/Separation stage
32 Inlet line
34 Outlet line
36 Discharge line
38 Lamella-separator/Separation stage
40 Lamellae
42 Inlet line
44 Gas outlet line
46 Water outlet line
48 Sludge outlet line
50 Storage container

1. A plant (10) for the purification of waste and/or process water by means of anaerobic microorganisms (22), wherein the plant (10) comprises:
i) a reactor tank (12) for the anaerobic purification of waste and/or process water with at least one feed line (20) for supplying waste and/or process water to be purified into the reactor tank (12) as well as with at least one outflow line (28) for draining a mixture of anaerobic microorganisms (22), waste and/or process water and gas from the reactor tank (12),
ii) a first separation apparatus (14) arranged outside and downstream of the reactor tank (12) for separating at least a part of the anaerobic microorganisms (22) in form of sludge from the mixture drained from the reactor tank (12), wherein the first separation apparatus (14) comprises at least one separation stage (30), an inlet line (32) being connected with at least one of the at least one outflow line (28) of the reactor tank (12), at least one discharge line (36) and at least one outlet line (34), and
iii) a return line (18) for returning the sludge separated in the first separation apparatus (14) into the reactor tank (12), wherein the return line (18) is connected with at least one of the at least one outlet line (34) of the first separation apparatus (14)
wherein the first separation apparatus for separating the anaerobic microorganism from the purified water and the gas can be maintained without necessarily terminating the operation of the reactor tank and at least without discharging the reactor tank.

2. The plant (10) according to claim 1, wherein the first separation apparatus (14) comprises as separation stage(s) one or more centrifugal separators and/or one or more lamella-separators.

3. The plant (10) according to claim 2, wherein the first separation apparatus (14) comprises as separation stage(s) one or more cyclones (30).

4. The plant (10) according to claim 1, wherein the first separation apparatus (14) is in the plant (10) lower than the upper end of that outflow line (28) of the reactor tank (12), with which the inlet line (32) of the first separation apparatus (14) is connected, so that the mixture drained from the reactor tank (12) flows gravity driven from that outflow line (28) of the reactor tank (12) into the inlet line (32) of the first separation apparatus (14).

5. The plant (10) according to claim 1, wherein the first separation apparatus (14) comprises one cyclone (30), wherein the cyclone (30) is connected with the inlet line (32), with one of the at least one outlet line (34) and further with one of the at least one discharge line (36) for discharging from the cyclone (30) a mixture of anaerobic microorganisms (22), waste and/or process water and gas, which is depleted in the content of anaerobic microorganisms (22) compared with the mixture drained from the reactor tank (12), wherein the outlet line (34) to which the first cyclone (30) is connected, is connected with the return line (18).

6. The plant (10) according to claim 1, wherein the first separation apparatus (14) comprises two cyclones (30), wherein the first of the two cyclones (30) is connected with the inlet line (32), with one of the at least one outlet line (34) and further with one of the at least one discharge line (36) for discharging from the first cyclone (30) a mixture of anaerobic microorganisms (22), waste and/or process water and gas, which is depleted in the content of anaerobic microorganisms (22) compared with the mixture drained from the reactor tank (12), and wherein the second of the two cyclones is connected with the discharge line (36) from the first cyclone (30), with another one of the at least one outlet line and further with another one of the at least one discharge line for discharging from the second cyclone a mixture of anaerobic microorganisms (22), waste and/or process water and gas, which is depleted in the content of anaerobic microorganisms (22) compared with the mixture drained from the first cyclone (30), wherein the outlet line (34) to which the first cyclone (30) is connected and the outlet line to which the second cyclone is connected, are connected with the return line (18).

7. The plant (10) according to claim 1, which further comprises a second, three-phase separation apparatus (16) arranged downstream of the first separation apparatus (14) for separating the mixture withdrawn from the discharge line (36) of the first separation apparatus (14) into a gas-rich phase, into a water-rich phase and into a sludge-rich phase, wherein the second, three-phase separation apparatus (16) comprises at least one separation stage (38), an inlet line (42) being connected with the discharge line (36) of the first separation apparatus (14), at least one gas outlet line (44), at least one water outlet line (46) and at least one sludge outlet line (48), wherein the at least one sludge outlet line (48) is connected with the return line (18).

8. The plant (10) according to claim 7, wherein the second, three-phase separation apparatus (16) comprises as separation stage(s) one or more lamella-separators (38).

9. The plant (10) according to claim 7, wherein the second, three-phase separation apparatus (16) comprises one lamella-separator (38), wherein the lamella-separator (38) is connected with the inlet line (42), wherein the lamella-separator (38) comprises a gas outlet line (44), a water outlet line (46) and a sludge outlet line (48), wherein the sludge outlet line (48) is connected with the return line (18).

10. The plant (10) according to claim 7, wherein the second, three-phase separation apparatus (16) comprises two lamella-separators (38), wherein the first of the two lamella-separators (38) is connected with the inlet line (42), wherein the first lamella-separator (38) comprises a gas outlet line (44), a water outlet line (46) and a sludge outlet line (48), and wherein the second of the two lamella-separators is connected with the water outlet line (46) from the first lamella-separator (38) and further comprises a gas outlet line, a water outlet line and a sludge outlet line, wherein the sludge outlet line (48) of the first lamella-separator (38) and the sludge outlet line of the second lamella-separator are connected with the return line (18).

11. The plant (10) according to claim 1, wherein the return line (18) comprises a storage container (50) to even changes of flow stream through the first separation apparatus (14) to ensure a constant fluid flow returned via the return line (18) into the reactor tank (12).

12. The plant (10) according to claim 1, wherein the reactor tank (12) comprises one or more overflows (26), wherein each of which is connected with one of the at least one outflow line (28) for draining a mixture of anaerobic microorganisms (22), waste and/or process water and gas from the reactor tank (12).

13. The plant (10) according to claim 12, wherein each of the one or more overflows (22) comprises at least two vertically arranged or sloped lamellae (40), wherein all lamellae (40) are arranged in parallel with each other to define flow paths there between, so that the separation of gas from the waste and/or process water is facilitated.

14. The plant (10) according to claim 1, wherein the upper part of the reactor tank (12) is conically so that gas may be collected there.

15. The plant (10) according to claim 1, wherein the reactor tank (12) does not comprise any gas hood and/or any other separation means for keeping the biomass in the reactor tank (12).

16. The plant (10) according to claim 1, wherein the reactor tank (12) comprises a mixer (24) for improving the mixing of the waste and/or process water and the microorganism (22).

17. A plant (10) for the purification of waste and/or process water by means of anaerobic microorganisms (22), wherein the plant (10) comprises:
i) a reactor tank (12) for the anaerobic purification of waste and/or process water with at least one feed line (20) for supplying waste and/or process water to be purified into the reactor tank (12) as well as with at least one outflow line (28) for draining a mixture of anaerobic microorganisms (22), waste and/or process water and gas from the reactor tank (12),
ii) a first separation apparatus (14) arranged outside and downstream of the reactor tank (12) for separating at least a part of the anaerobic microorganisms (22) in form of sludge from the mixture drained from the reactor tank (12), wherein the first separation apparatus (14) comprises at least one separation stage (30), an inlet line (32) being connected with at least one of the at least one outflow line (28) of the reactor tank (12), at least one discharge line (36) and at least one outlet line (34), wherein the first separation apparatus (14) comprises as separation stage(s) one or more cyclones (30), and
iii) a return line (18) for returning the sludge separated in the first separation apparatus (14) into the reactor tank (12), wherein the return line (18) is connected with at least one of the at least one outlet line (34) of the first separation apparatus (14).

18. The plant (10) according to claim 17, wherein the reactor tank (12) does not comprise any gas hood and/or any other separation means for keeping the biomass in the reactor tank (12).

19. A method for purifying waste and/or process water by means of anaerobic microorganisms (22), which comprises the steps of:
a) feeding waste and/or process water into a reactor tank (12) of a plant (10) via at least one feed line (20),
b) draining a mixture of anaerobic microorganisms (22), waste and/or process water and gas from the reactor tank (12) and leading it into a first separation apparatus (14) and
c) returning sludge separated in the first separation apparatus (14) into the reactor tank (12) via a return line (18) wherein the first separation apparatus for separating the anaerobic microorganism from the purified water and the gas can be maintained without necessarily terminating the operation of the reactor tank and at least without discharging the reactor tank.
